(19) United States
(12) Patent Application Publication
(10) Pub. No.: US 2016/0188365 A1
(43) Pub. Date: Jun. 30, 2016

(54) COMPUTATIONAL UNIT SELECTION

(71) Applicant: Intel Corporation, Santa Clara, CA (US)

(72) Inventors: Devadatta V. Bodas, Federal Way, WA (US); Muralidhar Rajappa, Chandler, AZ (US); Justin J. Song, Olympia, WA (US); Andy Hoffman, Olympia, WA (US)

(73) Assignee: Intel Corporation, Santa Clara, CA (US)

(21) Appl. No.: 14/582,986

(22) Filed: Dec. 24, 2014

(51) Int. Cl. G06F 9/48; G06F 1/32; G06F 9/54

(52) U.S. Cl. CPC G06F 9/4881; G06F 9/542; G06F 1/3296

(57) ABSTRACT

A system and method for computing including compute units to execute a computing event, the computing event being a server application or a distributed computing job. A power characteristic or a thermal characteristic, or a combination thereof, of the compute units is determine. One or more of the compute units is selected to execute the computing event based on a selection criterion and on the characteristic.

### CROSS-REFERENCE TO RELATED APPLICATIONS

The present application is related to the U.S. patent application Ser. No. ______ (Attorney Docket No. 42P73498) entitled ______ filed ______; the U.S. patent application Ser. No. ______ (Attorney Docket No. 42P74562) entitled ______ filed ______; the U.S. patent application Ser. No. ______ (Attorney Docket No. 42P74566) entitled ______ filed ______; the U.S. patent application Ser. No. ______ (Attorney Docket No. 42P74567) entitled ______ filed ______; the U.S. patent application Ser. No. ______ (Attorney Docket No. 42P74568) entitled ______ filed ______; the U.S. patent application Ser. No. ______ (Attorney Docket No. 42P74569) entitled ______ filed ______; the U.S. patent application Ser. No. ______ (Attorney Docket No. 42P74564) entitled ______ filed ______; the U.S. patent application Ser. No. ______ (Attorney Docket No. 42P74565) entitled ______ filed ______; and the U.S. patent application Ser. No. ______ (Attorney Docket No. 42P74563) entitled ______ filed ______.

### TECHNICAL FIELD

The present techniques relate generally to computing. More particularly, the techniques relate to selection of computational units from a distribution to perform computing, the selection based on a criterion.

### BACKGROUND ART

For some systems and computing configurations, virtual and non-virtual, to perform a computing job, task, service, etc., a number of computational units (e.g., compute nodes, processors, processor cores, servers, etc.) may be selected from a distribution of the computational units. For example, in providing a web service, six servers in a web service system may be available, and two servers selected from among the six servers to perform the computation of a particular web service. In another example, a cloud computing task may be performed by selecting a number (e.g., hundreds or thousands) of compute nodes or processors from a computing system having a distribution of compute nodes or processors.

A particular example of selection of computational units may be in distributed computing, such as High Performance Computing (HPC). In general, HPC may facilitate scientists and engineers to solve complex science, engineering, and business problems using applications that benefit from high bandwidth, low latency networking, and very high compute capabilities. Such HPC systems may also execute data storage and retrieval, perform more straightforward tasks, and so on. Unfortunately, HPC systems, which generally have thousands of compute nodes performing tasks, typically consume significant power. Such may be especially problematic in the “Big Data” era. Further, variations in power consumption and issues of power allocation may also be problematic.

The competitive business of data and computing services drives manufacturers in the continuous improvement of their processes and products in order to lower production costs and deliver reliable service. Indeed, as technologies advance in services for data, computing, and telecommunications, a competitive need exists to continuously increase consistency of service and the efficiency of power utilization.

### BRIEF DESCRIPTION OF DRAWINGS

FIG. 1 is a diagrammatical representation of an exemplary distributed computing facility in accordance with embodiments of the present techniques.

FIG. 2 is an exemplary distribution plot of quantity of nodes or processors of an HPC system versus actual thermal design power (TDP).

FIG. 3 is a distribution plot with an exemplary indication of am example selection criterion in accordance with embodiments of the present techniques.

FIG. 4 is a distribution plot with an exemplary indication of another example selection criterion in accordance with embodiments of the present techniques.

FIG. 5 is a block diagram indicating general data collection in calibration in accordance with embodiments of the present techniques.

FIG. 6 is a block flow diagram depicting one example of a method of selecting nodes or processors for a distributed computing job in accordance with embodiments of the present techniques.

FIG. 7 is a block diagram depicting an example of a tangible non-transitory, computer-readable medium that can facilitate node selection in accordance with embodiments of the present techniques.

FIG. 8 is a computing system having a plurality of compute units in accordance with embodiments of the present techniques.

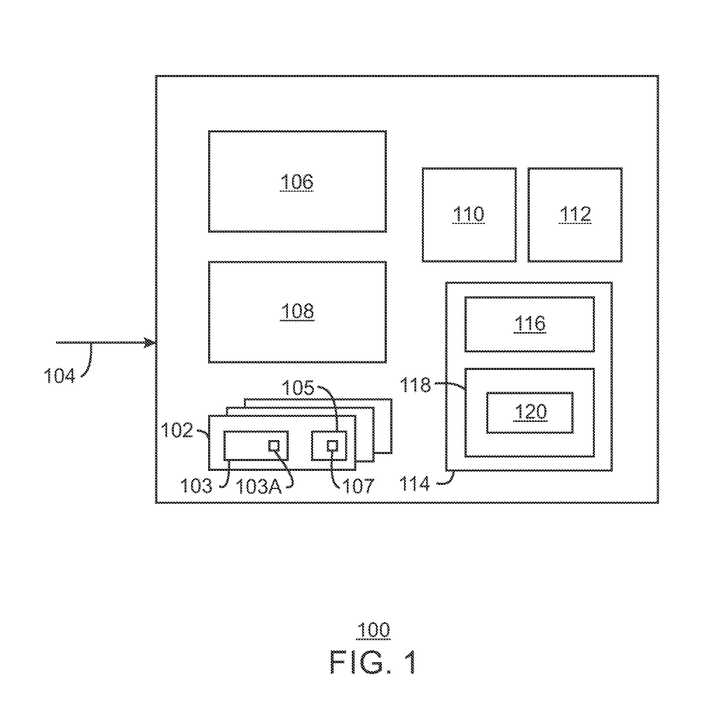

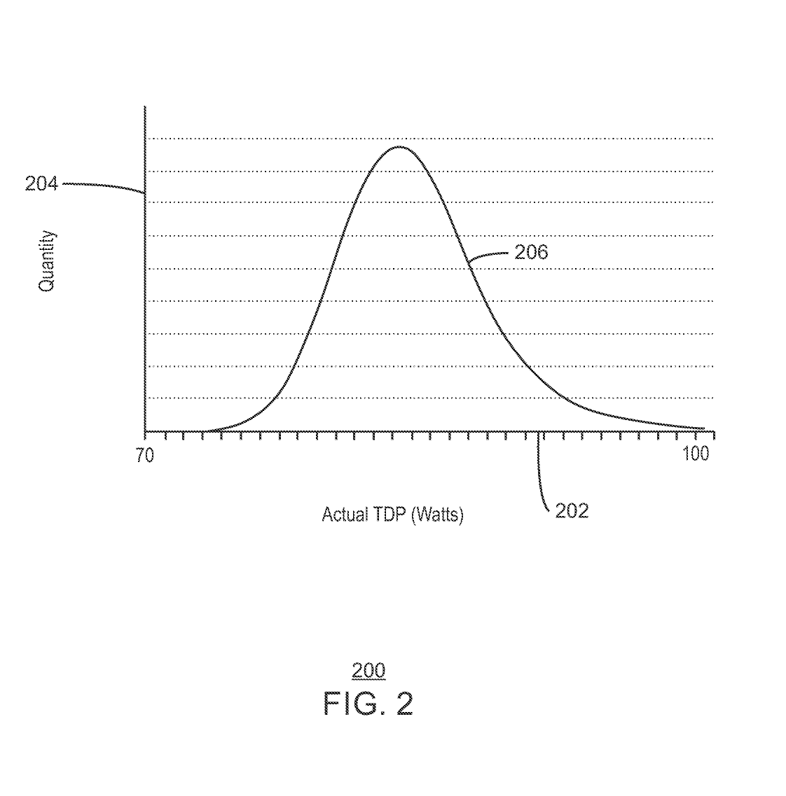

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION

Embodiments of the present techniques relate to computing systems including distributing computing systems or server systems, and so on. Embodiments may involve calibrating nodes (or processors or processor cores) of a distributed computing system, or server systems of a web services system, and so on, to determine a power and/or thermal characteristic, and/or a power profile or thermal profile, and so on, of the nodes or servers. Embodiments may specify or receive a power criterion or thermal criterion, and select nodes, processor cores, processor packages, processors, or servers etc., to execute a job of distributed computing or an application, based on the power criterion, thermal criterion, power characteristic or profile, thermal characteristic or profile, and other factors.

In high performance computing (HPC), delivering reasonable computing performance may be difficult and a significant challenge when power to a HPC system is limited. Certain embodiments herein facilitate “cherry picking” of compute nodes to address power limitations and the competitive HPC business of delivering high performance.

FIG. 1 is a diagrammatical representation of a distributed computing facility 100 such as a HPC facility, Big Data analytics facility, datacenter, telecommunications center, and so on. The depiction of the computing facility 100 may represent a single facility or multiple facilities across geographical locations. In the illustrated embodiment, the distributed computing facility 100 has nodes 102. In examples, the number of nodes 102 may be as many as 16, 100, 2,000, 5,000, 10,000, 20,000, 40,000, 60,000, 100,000, 1,000,000, or greater. Of course, in other applicable computing systems, the number of computational units may be as few as 2 or 4. Moreover, in certain embodiments of FIG. 1, the nodes 102 may generally be compute nodes and also include one or more operating system (OS) nodes, input/output (I/O) nodes, and so forth.

Each node 102 typically includes one or more processors 103, such as a central processing unit (CPU). Indeed, each node 102 may have a CPU processor package including multiple processors 103. Further, each processor 103 has one or more processing cores 103A. For example, a processor 103 may have ten cores 103A. In addition, each node 102 may have memory 105 storing code 107 (i.e., logic, modules, instructions, etc.) executable by the processor 103 or other processor. The code 107 may include a node manager, job manager, and the like, to facilitate execution of tasks and adjustment of the tasks with respect to power and performance. The nodes 102 may include other hardware, software, and firmware, may be housed in racks, for example, and may be grouped into systems or groups of nodes 102, and so forth.

The facility 100 receives power, as indicated by reference numeral 104. The power may be electricity received from one or more electricity providers such as a utility company. As can be appreciated, the compute nodes 102 and other computing devices in the facility 100 generally require power or electricity as electronic devices in computing and executing tasks. Further, other systems such as lighting and cooling systems, represented by blocks 106 and 108, respectively, may consume power. Moreover, in certain embodiments, the facility 100 may include alternate or local power generation systems 110 (e.g., diesel generators, etc.) and/or battery or power storage systems 112.

In addition, the facility 100 generally includes one or more computing devices 114 (e.g., servers) which may be disposed locally within the facility 100 and/or remote to the facility 100. The computing device(s) 114 may include one or more processors 116 (e.g., CPU) and memory 118. Various manager modules or code 120 may be stored in the memory 118 and executable by the processor(s) 116. For example, the executable code 120 and/or the aforementioned executable code 107 on the nodes 102 may include a job manager that may assign and manage tasks across the compute nodes 102, including with respect to power consumption. Other examples of manager modules in the server executable code 120 and/or in the node executable code 107 include a facility power manager, resource manager, system power managers (e.g., for groups of nodes), rack managers, node power managers, and so on. Moreover, a compute node can be a server or a board, and/or several compute nodes may be on one board.

Unfortunately, computer systems, such as a supercomputer (HPC), Big Data analytics, and search engines, etc., that use a large number of compute nodes are facing power as a barrier. These systems may use thousands of compute nodes (e.g., having processors, central processing units or CPUs, cores, etc.), such as with servers, to run distributed computing jobs submitted by users. As part of a job submission, a user typically specifies number of processors that could be translated into number of compute nodes and compute node cores needed for the job. A job waits in a queue until those specified resources including many nodes are available for the job.

Thousands of compute nodes do computation in parallel for a job. Latency for communication between these nodes can have a large impact on performance for the job. Traditionally, the selection of nodes is based upon communication topology to keep the latency at minimal. Compute nodes are homogeneous in having the same or identical specified hardware and software configuration. Most or all of the nodes in a job also generally run same application. Thus, power and performance of these nodes is expected to be similar or the same per node. However, these homogenous nodes running the exact same application, performing the exact same computation, can have power consumption vary as much as 25% per node. This means when you have to select 3000 nodes from 5000 free nodes, for example, there may be an opportunity to pick 3000 nodes expending lower (or the lowest) power. On the other hand, if higher power nodes are selected for the job, the execution of the job will expend greater power and may more likely exceed a power limit budget for the job.

Current and future HPC systems are expected to run in a power-constrained environment. Therefore, a distributed computing job may have a limited power budget. Selection of high power nodes may lead to the power for the job to be higher than the available budget. If so, the job may have to wait in queue until there is more power or more power budget available. On the other hand, when power allocated to a job is limited, a job may be run by enforcing power limits on the nodes that run the job. Yet, high power nodes may throttle significantly and cause longer time to complete the job.

Nodes while running a job may have a similar amount of computation and synchronize with each other hundreds of times a second. The slowest node to arrive at point of synchronization can result in the remaining nodes waiting and, therefore, degradation in performance and wasted power. Conversely, HPC users expect nodes in a job to have identical behavior or time for completion′. However, with up to 25% and greater variation in power, fulfilling this expectation can be very challenging.

When subjected to a power limit, a job scheduler may require or benefit from an estimate for power needed to run the distributed computing job. Conventionally, any estimation of power is based upon the maximum thermal design power (TDP) specification of the nodes or processors. For most applications, actual power consumption by most components and nodes of the distribution is likely to be lower than the specified TDP. A job scheduled based upon specified TDP power estimation (higher) is likely to wait longer in a queue.

Embodiments of the present techniques make selection of nodes power aware. In other words, power-performance characteristics are considered and included with other criteria for selection of nodes for running a distributed computing job. There can be multiple power-related criteria for selection of nodes.

For example, a power criterion may be a low or lowest power profile in which lower or lowest power consumers of available eligible nodes are selected. Another criterion may be lowest node-to-node variation in which a group of nodes having less or least variation in performance are selected for executing the distributed computing job. A combination these two criterion, lowest power with least variation (i.e., lowest wait time for synchronization) may result in result in relatively low power and relatively high performance.

FIG. 2 is a distribution plot 200 of quantity 204 of nodes or processors (of an HPC system) versus actual TDP in Watts, noted by reference numeral 202. Thus, the distribution plot 200 provides a power profile of the nodes or processors. The distribution curve 206 of FIG. 2 is an arbitrary example for discussion and reflecting a distribution of manufactured components.

Thermal design power (TDP) specification is a processor specification that provides power and cooling requirement for the processor. Each model number of a processor may have a unique TDP specification. A system designer of a system employing the processors may ensure that the power delivery (VR) and cooling (heat sinks and airflow) solutions are adequate for the specified TDP. The TDP may represent the worst case power requirements for a processor because the manufacturer of the processor may assign a TDP of the worst-case processor of that model number. Nevertheless, when a user system employing processors supports a processor model number “xyz” with say 100 W TDP, this generally means that the user system design incorporates power delivery and cooling for any processor with TDP up to 100 W.

Continuing with this example, millions of processors may be manufactured as model “xyz.” These processors have variation in chemical and electrical composition. Consequently, actual worst case power or TDP for each of these processors can be different. From all of the processors manufactured for model xyz only those processors that have actual TDP less than or equal to 100 W can typically be selected to be labeled as model xyz with TDP specification of 100 W. In other words, the actual worst case power or actual TDP of processor with model number xyz can vary to lower than 100 W. FIG. 2 shows an arbitrary example of distribution of actual TDP of processor with TDP specification of 100 W.

In this example of FIG. 2, if a resource manager on the HPC system needs to select 1000 processors for a job, differing power results can occur depending on the particular 1000 processors selected. In an extreme case (A) with the selected processors or parts are all close to actual TDP 202 of 100 W, such will indicate that the job needs approximately 100 KW of power to run. In contrast, a power-aware selection case (B) may lead to selecting 1000 processors or parts closer to actual TDP 202 of 80 W. This means the job power would be approximately 80 KW, or about 20 KW or 20% lower than the aforementioned extreme case (A). Another benefit of case (B) relative to case (A) is that in case (A), the job will have to wait until 100 KW or more power is available. In contrast, for case (B), job can start when just 80 KW or more is available.

In a power-constrained environment, consider an instance if the job has limited power budget in that the power consumption of a processor is limited to 90 W, for example. In case (A), depending upon software and thermal conditions, the processors or parts may throttle and operate at much lower than the P-state P1 frequency of 2.7 GHz. However, in the beneficial case (B), even with processor (CPU) power limit of 90 W, the processors may likely run at an accelerated or turbo frequency of 3.1 GHz, for example.

As discussed below, three steps or general factors to consider for power-aware selection of nodes may be (1) calibration of nodes, (2) selection criteria, and (3) use cases to develop, implement, or dictate selection criteria. As for the first step or general consideration, calibration of nodes, the processor (e.g., CPU) or node power is measured. Most or all of the processors may have the identical part number or model number and have the same specified TDP power. However, as part of commissioning, booting, or maintenance of a node, for example, a calibration cycle should be performed. In the calibration, the processor or node power may be measured while running multiple sample programs or workloads. The sample programs may represent various user applications. These results from calibration may be stored locally in a shared file system, for instance, or in a database for future use, and so forth. In general in the calibration, average power, maximum power, temperature of components (including critical components), and performance may be logged.

Two types of calibrations are TDP calibration and workload calibration. For TDP calibration, a power-thermal utility may be run to measure maximum or near maximum node power. For workload calibration, because TDP may represent one extreme or worst case, sample workloads that represent user applications may be run to measure the node power. Calibration of nodes can be performed for user-defined frequencies or all plausible frequencies a node can operate at. Node power numbers while running a sample workload and TDP workload operating at each frequency is stored into a database. This calibration data may provide at least three improvements in accuracy in selection of nodes. First, actual power consumption of each node is measured, and that comprehends manufacturing variations. Second, power running sample workloads are very different (mostly lower than TDP power) and closer to power that would be consuming while running actual user application. Third, when subjected to power limit, a user application may not run when processor operates at the highest possible frequency. Calibration data may provide node power estimate for the frequency at which node can operate while power constrained.

As mentioned, a second step or general factor to consider for power-aware selection of nodes is selection criteria. There may be number of selection criteria: (a) lowest power, (b) least node-to-node variation, (c) highest power nodes, and so forth. For a selection criterion of lower or lowest power, the lower or lowest power nodes of the available, eligible nodes may be selected. This may be desirable or most desired to improve chances for a job to be scheduled and executed. This lowest power criterion will also generally deliver lower energy consumed by the node. Yet, such may not be a better or the best option for energy efficiency of a job on the distributed computing or HPC system.

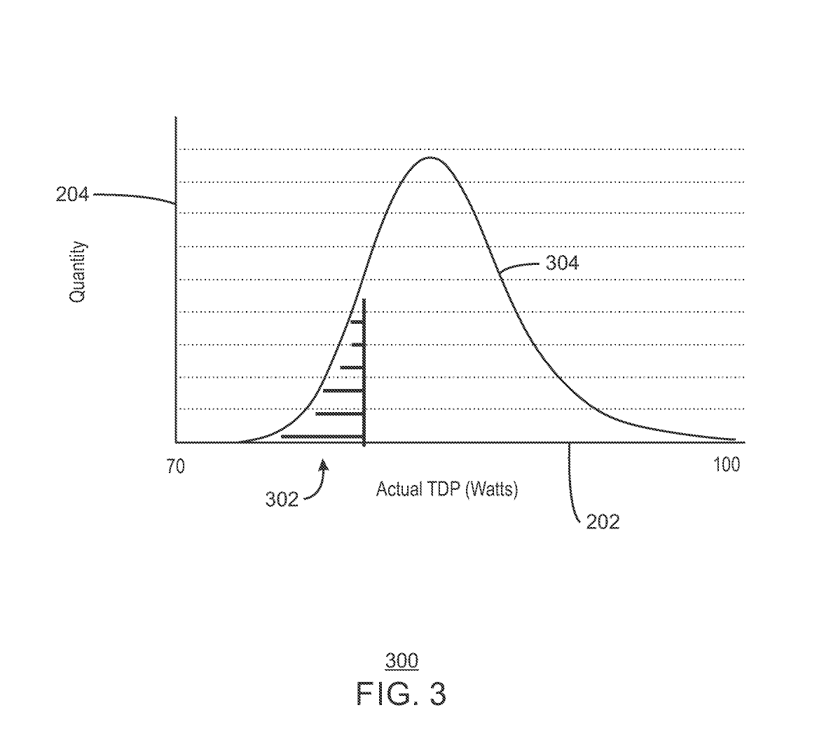

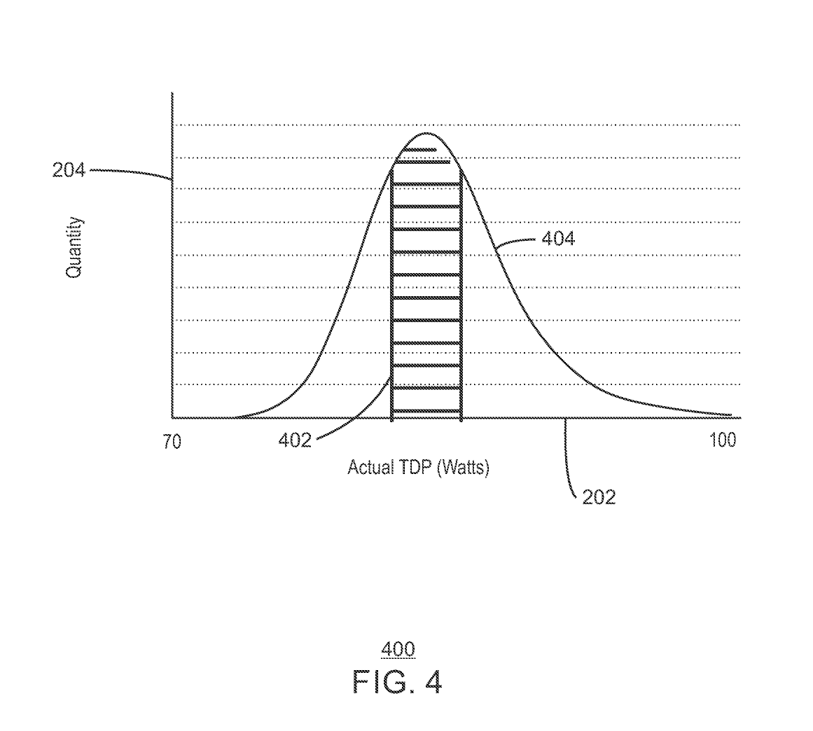

FIG. 3 is a distribution plot 300 with an exemplary indication 302 of the selection criterion of lower or lowest power. The plot 300 shows a marked region as the indication 302 of selecting lower or lowest power nodes (or processors) from the distribution. FIGS. 3 and 4 are distribution of power consumption by nodes for given respective application (TDP or workload) and for a given frequency (maximum or user specified). Lastly, it should be noted that FIGS. 3 and 4 have the same axes 202 and 204 as FIG. 2.

FIG. 4 is a distribution plot 400 with an exemplary indication 402 of the selection criterion of less or least node-to-node variation. The plot 400 of FIG. 4 shows a marked region as the indication 402 of selecting nodes (or processors) that are near or closest to the median of the actual TDP power distribution. Such selection may provide for less or least node-to-node variation with respect to power, and with respect to performance in certain instances while operating under a power limit.

As mentioned, another selection criterion is high or highest power nodes, which may be an inverse or inverse-like of the criterion to select the lower or lowest power nodes. A utility or energy producer (or provider) may require large datacenters to consume most or all power that is allocated to the datacenter from the utility provider. Therefore, when most or all “green” avenues are implemented, there may be a need to consume power to maintain higher power consumption so not to drop below allocation.

As listed above, a third step or general factor to consider for power-aware selection of nodes is use cases to dictate selection criteria. Facility, administrative, and user preferences for power and energy provide input to which criteria should be used to select nodes for a job. Users typically desire high usage efficiency, Indeed, most or all HPC users may desire that 100% of the nodes in a system are used to run jobs. In a power constrained environment, the lowest power criteria for selection of nodes may be used in this case, for example. Further, for jobs that cannot be suspended, the distributed computing jobs on an HPC system may run for hours or months. Many HPC jobs have built in capability that allows job to be suspended in the middle of an execution and resumed from the point of suspension. However not all jobs have this capability. In some cases, a user may prefer that once a job gets started, the job is rarely or never suspended. Power allocation for such non-suspend jobs cannot fall below a minimum, even when power allocation to the system reduces. To facilitate that the non-suspend jobs are not stopped or killed, the lowest power criteria may be required or implemented.

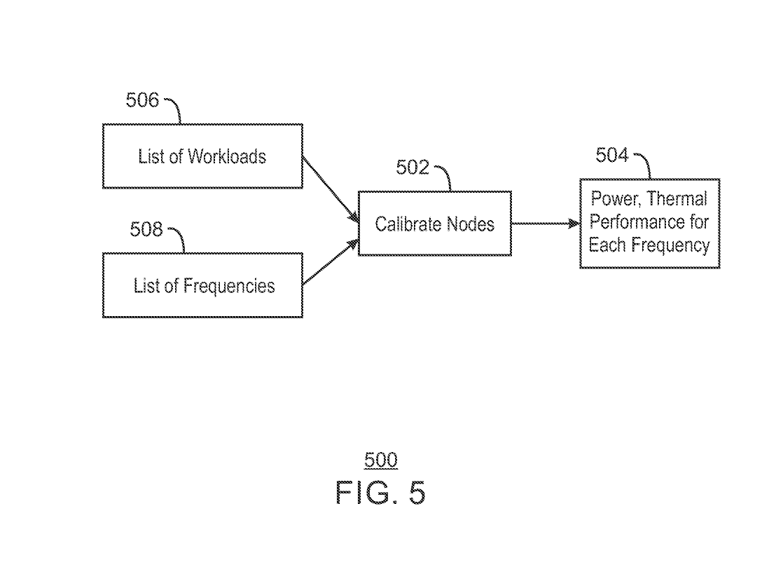

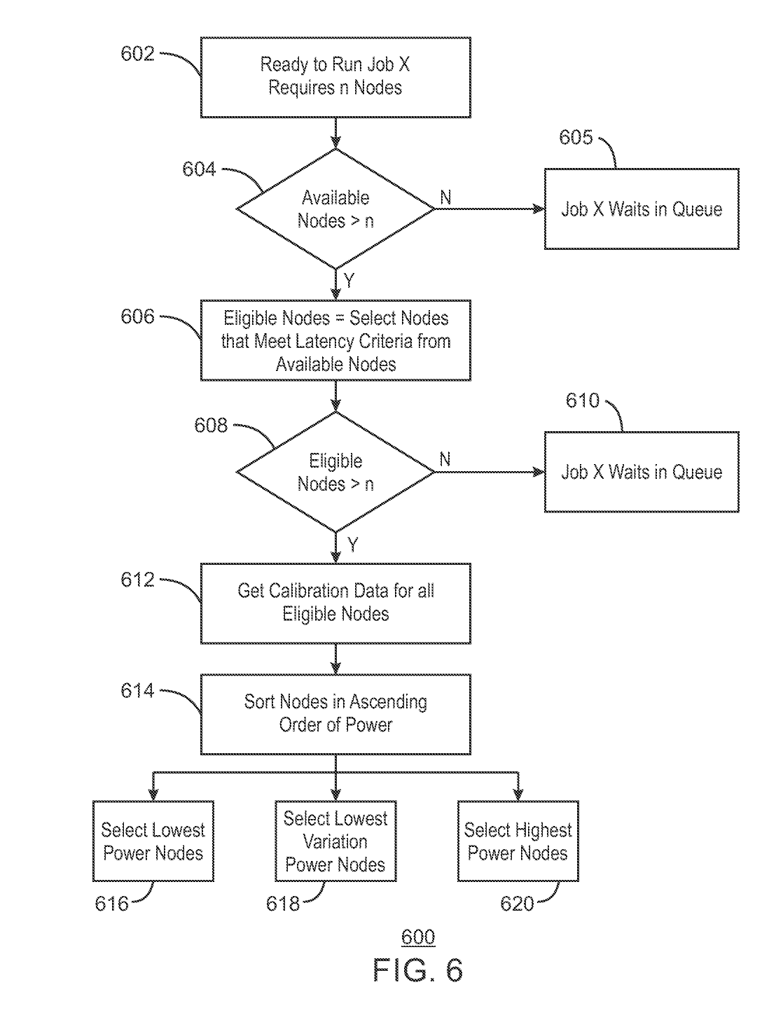

Further, consider highly deterministic performance. HPC jobs are generally executed or run by dividing work in thousands parallel tasks. These tasks synchronize with each other hundreds of times a second to make forward progress. To ensure or facilitate reduced (or minimal) wait time up to and at synchronization point may benefit from or require that the nodes have very low variation in performance. Thus, a low or least node-to-node variation criterion may be beneficial or necessary for this usage. The following two figures, FIG. 5 and FIG. 6, provide example overviews of techniques of selection of nodes for a distributed computing job and to address power and performance.

FIG. 5 is a block diagram 500 indicating general calibration data collection. Calibration (measurement) may be performed when processors or nodes are offline or not in use for a job, or during run time of a job with collecting actual data when an application runs. To measure power and thus calibrate nodes (block 502), a list of workloads or sample programs (block 506) and a list of frequencies (block 508) may be utilized. As referenced in block 504, the power, thermal values, performance, and so on, may be measured and collected for each node or processor at each operating frequency of the node or processor.

FIG. 6 is a block flow diagram 600 depicting one example of a method or process flow of selecting nodes or processors for a distributed computing job on an distributed computing (e.g., HPC) system. The exemplary diagram 600 may be an exemplary overview of how “n” nodes or processors may be selected for job that needs “n” nodes or processors. In illustrated particular example, the lower or lowest power nodes are eventually selector. However, other examples may select based on other power criteria. Moreover, other factors and issues not depicted in FIG. 6 may be considered.

Initially, block 602 indicates that a Job X is ready to run (execute) and needs or desires “n” number of nodes. Block 604 is a decision block that asks if there are “n” or more nodes available on the HPC system. If “n” or more nodes are not available, then Job X waits in queue, as referenced by block 605. If “n” or more nodes are available, then eligible nodes are considered (block 606). In particular, available nodes may be considered eligible if meeting latency criteria or other factors. Then, block 608, a decision block, asks if “n” or more nodes are eligible. If not, the Job X may wait if queue (block 610). On the other hand, if “n” or more nodes are eligible, the calibration data for most or all eligible nodes may be gathered or retrieved (block 612), and the nodes and their data sorted in a list of ascending order of power (block 614). Lastly, to perform a computing job, “n” nodes of the available eligible nodes may be selected from the list mentioned in block 612. Various criteria may be employed to decide the selection of the nodes. For example, with lowest power criterion, the “n” number of the eligible nodes having the lowest power may be selected (block 616). In another example, with a lowest variation power criterion, the “n” number of the eligible nodes having the least power variation, such as generally closer to the median power, may be selected (block 618). In yet another example, such as with a highest power criterion, the “n” number of eligible nodes having the highest power may be selected (block 620). Of course, other examples are applicable.

Furthermore, the criterion may be a thermal criterion instead of a power criterion, or the criterion may be a combined thermal and power criterion. Thus, the selection of the compute units may be power-aware or thermal-aware, or both. The compute units may be examined or calibrated to determine a power characteristic or a thermal characteristic, or a combination. The compute units may be examined, measured, or calibrated to determine a power profile and a thermal profile. Such profiles may indicate variations in power and temperature, respectively, in the distribution of compute units. The variations may be due to manufacturing component variations, for example.

The thermal criterion may be a lower or lowest temperature criterion, a higher or highest temperature, or other thermal criterion. In a particular example, a system for computing may be multiple server systems (e.g., hundreds of server systems) for web services or other applications. Thermal characteristic(s) or a temperature profile of the distribution of the multiple server systems may be obtained. In the measurement or calibration, a sample application may be executed on the servers. Temperature variations server-to-server may be due, in part, to manufacturer component variations of the servers. In many cases servers are cooled by blowing air on heat sinks or components. In many cases temperature of air that is used for cooling varies based upon physical location of components and physical servers in racks and datacenter. This variation also contributes to variation in temperature of components and servers.

Continuing with this example, the selection of “n” servers of the multiple servers to run a web service application or other application may be based, in part, on the thermal characteristics or thermal profile. The selection of lower or lowest temperature servers may be beneficial for running high-power applications, for example. The selection of higher or highest temperature servers may be beneficial for running lower power applications, to increase utilization of more server systems, and so forth.

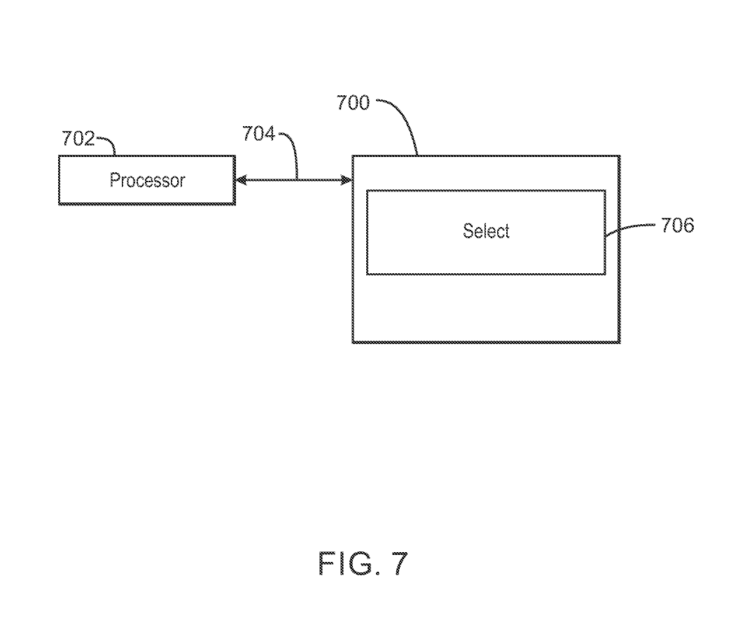

FIG. 7 is a block diagram depicting an example of a tangible non-transitory, computer-readable medium that can facilitate power management of a distributed computing system in accordance with embodiments of the present techniques. The computer-readable medium 700 may be accessed by a processor 702 over a computer interconnect 704. The processor 702 may be one or more compute node processors (e.g., 103), a server processor (e.g., 116), or another processor. The tangible, non-transitory, computer-readable medium 700 may include executable instructions or code to direct the processor 702 to perform the operations of the techniques described herein.

The various software components discussed herein may be stored on the tangible, non-transitory, computer-readable medium 700, as indicated in FIG. 7. For example, an power management/control module 706 (executable code/instructions) may direct the processor 702 to manage and control power consumption and variation at a distributed computing facility. The code or module 706 may be similar or the same as the aforementioned executable code 107, 120 in FIG. 1. It should be understood that any number of additional software components not shown in FIG. 7 may be included within the tangible, non-transitory, computer-readable medium 700, depending on the application.

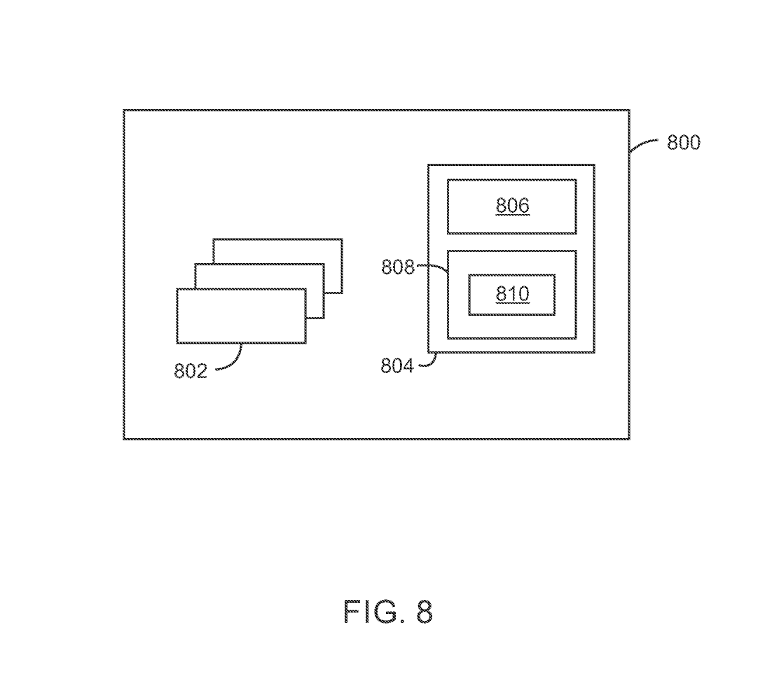

FIG. 8 is a computing system 800 having a plurality or distribution of compute units 802. The compute units may be processor cores, processors e.g., central processing units or CPUs), processor packages, compute nodes, server systems, and so on. In one example, the computing system 800 is a distributed computing system. In another example, the computing system 800 is a group of server systems, and the compute units 802 are server systems. In another example, the computing system 800 is a high performance computing (HPC) system. Additionally, the computing system 800 may include on or more servers 804, each having a processor 806, and memory 808 storing code executable by the processor 806. The code 810 may be executable to implement the techniques discussed throughout the present disclosure.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

Examples are provided. Example 1 is a system for computing. The system includes compute units configured to execute a computing event, the computing event includes a server application or a distributed computing job. The system has memory storing code executable by the compute units or a processor to calibrate the compute units to determine a characteristic of the compute units, the characteristic including a power characteristic or a thermal characteristic, or a combination thereof. The code is executable by the processor to receive a selection criterion, and select one or more of the compute units to run the computing event based on the selection criterion and on the characteristic.

Example 2 incorporates the subject matter of Example 1. In this example, the compute units include a processor core, a processor, a processor package, a compute node, or a server system, or any combination thereof.

Example 3 incorporates the subject matter of any combination of Examples 1-2. In this example, the selection criterion includes a power criterion of lower or lowest power.

Example 4 incorporates the subject matter of any combination of Examples 1-3. In this example, the selection criterion is a power criterion that is low variation of power compute unit-to-compute unit.

Example 5 incorporates the subject matter of any combination of Examples 1-4. In this example, the selection criterion includes a high power criterion, and wherein to select the one or more compute units increases power consumption of the computing event as executed to meet a specified allocation of power for a facility comprising the system for computing.

Example 6 incorporates the subject matter of any combination of Examples 1-5. In this example, the compute units include compute nodes or processors, or a combination thereof, and wherein the system is a distributed computing system having the compute nodes or processors, or both.

Example 7 incorporates the subject matter of any combination of Examples 1-6. In this example, the system is a distributed computing system, wherein the computing event is a distributed computing job, and wherein to select the one or more compute units increases the power consumption of the distributed computing job as executed to meet a specified allocation of power for a facility having the distributed computing system.

Example 8 incorporates the subject matter of any combination of Examples 1-7. In this example, the selection criterion includes a lower or lowest power criterion, and wherein to select the one or more compute units decreases power consumption of the computing event as executed.

Example 9 incorporates the subject matter of any combination of Examples 1-8. In this example, the selection criterion specifies lower power consumption and lower power variation, the power characteristic is a power profile, and the thermal characteristic is a thermal profile.

Example 10 incorporates the subject matter of any combination of Examples 1-9. In this example, wherein the computing event is a distributed computing job, the compute units are nodes, and the selection criterion is a power criterion involving node-to-node variation of power.

Example 11 incorporates the subject matter of any combination of Examples 1-10. In this example, to select the one or more nodes is to decrease the node-to-node variation of the power of the job as executed to reduce task wait time to synchronization.

Example 12 incorporates the subject matter of any combination of Examples 1-11. In this example, wherein the selection criterion is a thermal criterion.

Example 13 incorporates the subject matter of any combination of Examples 1-12. In this example, the compute units are nodes, and where to calibrate the nodes includes to measure power of the nodes as a function of operating frequency of the nodes.

Example 14 incorporates the subject matter of any combination of Examples 1-13. In this example, to select the one or more of the compute units includes to select available compute units of the compute units.

Example 15 incorporates the subject matter of any combination of Examples 1-14. In this example, to select the one or more of the compute units includes to select available compute units as eligible based on latency criteria.

Example 16 is a method of computing. The method includes calibrating, via a processor, compute units of a system of computing to determine a distribution characteristic of the compute units, the distribution characteristic comprising a power characteristic or a thermal characteristic, or a combination thereof. The method includes receiving, via the processor, a selection criterion, and selecting, via the processor and based on the selection criterion, one or more of the compute units to execute a computing event on the system. Further, the method includes executing the computing event on the one or more compute units as selected.

Example 17 incorporates the subject matter of Examples 16. In this example, the selection criterion includes a power criterion, and wherein the compute units are compute nodes or processors, or both.

Example 18 incorporates the subject matter of Example 17. In this example, the system is a distributed computing system, the computing event is a job of distributed computing, and wherein the power criterion includes a high power criterion to increase power consumption of the job as executed to meet a specified allocation of power for a facility comprising the computing system.

Example 19 incorporates the subject matter of any combination of Examples 16-18. In this example, the computing event is a distributed computing job and the compute units are compute nodes, wherein the selection criterion includes a power criterion comprising to select nodes giving less node-to-node variation of power of the distributed computing job to reduce task wait time to synchronization.

Example 20 incorporates the subject matter of any combination of Examples 16-19. In this example, the selection criterion includes a power criterion to decrease power consumption of the computing event as executed.

Example 21 incorporates the subject matter of any combination of Examples 16-20. In this example, the selection criterion includes a compute unit-to-compute unit variation in power.

Example 22 incorporates the subject matter of any combination of Examples 16-21. In this example, the compute units are a processor core, a processor, a processor package, a compute node, or a server system, or any combination thereof.

Example 23 incorporates the subject matter of any combination of Examples 16-22. In this example, the selection criterion includes a power criterion that is lower or lowest power.

Example 24 incorporates the subject matter of any combination of Examples 16-23. In this example, the selection criterion includes a power criterion that is low variation of power compute unit-to-compute unit.

Example 25 incorporates the subject matter of any combination of Examples 16-24. In this example, the distribution characteristic includes a power profile.

Example 26 incorporates the subject matter of any combination of Examples 16-25. In this example, the distribution characteristic includes a temperature profile.

Example 27 incorporates the subject matter of any combination of Examples 16-26. In this example, the selection criterion includes a high power criterion, and wherein selecting the one or more compute units increases power consumption of the computing event as executed to meet a specified allocation of power for a facility comprising the system for computing.

Example 28 incorporates the subject matter of any combination of Examples 16-27. In this example, the compute units include compute nodes or processors, or a combination thereof, and wherein the system is a distributed computing system having the compute nodes or processors, or both.

Example 29 incorporates the subject matter of any combination of Examples 16-28. In this example, the system is a distributed computing system, wherein the computing event is a distributed computing job, and wherein selecting the one or more compute units increases the power consumption of the distributed computing job as executed to meet a specified allocation of power for a facility having the distributed computing system.

Example 30 incorporates the subject matter of any combination of Examples 16-29. In this example, the selection criterion includes a lower or lowest power criterion, and wherein selecting the one or more compute units decreases power consumption of the computing event as executed.

Example 31 incorporates the subject matter of any combination of Examples 16-30. In this example, the selection criterion includes lower power consumption and lower power variation, the power characteristic includes a power profile, and the thermal characteristic includes a thermal profile.

Example 32 incorporates the subject matter of any combination of Examples 16-31. In this example, the computing event is a distributed computing job, the compute units include nodes, and the selection criterion includes a power criterion of node-to-node variation of power.

Example 33 incorporates the subject matter of any combination of Examples 16-32. In this example, selecting the one or more nodes decreases the node-to-node variation of the power of the job as executed to reduce task wait time to synchronization.

Example 34 incorporates the subject matter of any combination of Examples 16-33. In this example, the selection criterion is or includes a thermal criterion.

Example 35 incorporates the subject matter of any combination of Examples 16-34. In this example, the compute units are nodes, and wherein calibrating the nodes includes measuring power of the nodes as a function of operating frequency of the nodes.

Example 36 incorporates the subject matter of any combination of Examples 16-35. In this example, selecting the one or more of the compute units includes to select available compute units of the compute units.

Example 37 incorporates the subject matter of any combination of Examples 16-36. In this example, selecting the one or more of the compute units includes to select available compute units as eligible based on latency criteria.

Example 38 is a non-transitory, computer-readable medium having instructions executable by a processor to calibrate nodes of a distributed computing system to determine a power profile of the nodes, the nodes configured to execute a job of distributed computing. The instructions are executable by the processor to receive a power criterion, and to select one or more of the nodes to execute the job based on the power criterion and the power profile.

Example 39 incorporates the subject matter of Examples 38. In this example, the power criterion includes a lowest power or a lowest variation in power, or a combination thereof.

Example 40 incorporates the subject matter of any combination of Examples 38-39. In this example, the power criterion includes a highest power criterion, and wherein to select the one or more nodes increases the power consumption of the job as executed to meet a specified allocation of power for a facility having the distributed computing system.

Example 41 incorporates the subject matter of any combination of Examples 38-40. In this example, the power criterion includes to decrease node-to-node variation of the power of the job as executed to reduce task wait time to synchronization.

Example 42 is a distributed computing system, having means for calibrating nodes of the distributed computing system to determine a power profile of the nodes, the nodes configured to execute a job of distributed computing. The distributed computing system includes means for receiving a power criterion, and means for selecting one or more of the nodes to execute the job based on the power criterion and the power profile.

Example 43 incorporates the subject matter of Example 42. In this example, the power criterion includes a lowest power criterion or a lowest variation in power criterion, or a combination thereof.

Example 44 incorporates the subject matter of any combination of Examples 42-43. In this example, the power criterion includes a highest power criterion, and wherein to select the one or more nodes increases the power consumption of the job as executed to meet a specified allocation of power for a facility having the distributed computing system.

Example 45 incorporates the subject matter of any combination of Examples 42-44. In this example, the power criterion is to decrease node-to-node variation of the power of the job as executed to reduce task wait time to synchronization.

Example 46 is a system of computing, including means for calibrating compute units of the system of computing to determine a characteristic of the compute units, the characteristic including a power characteristic or a thermal characteristic, or a combination thereof. The system includes means for receiving a selection criterion, and means for selecting based on the selection criterion, one or more of the compute units to execute a computing event on the system. The system includes means for executing the computing event on the one or more compute units as selected.

Example 47 incorporates the subject matter of Examples 46. In this example, the selection criterion includes a power criterion, and wherein the compute units are compute nodes or processors, or both.

Example 48 incorporates the subject matter of any combination of Examples 46-47. In this example, the system is a distributed computing system, the computing event is a job of distributed computing, and wherein the power criterion includes a high power criterion to increase power consumption of the job as executed to meet a specified allocation of power for a facility having the distributed computing system.

Example 49 incorporates the subject matter of any combination of Examples 46-48. In this example, the computing event is a distributed computing job and the compute units are compute nodes, wherein the selection criterion includes a power criterion specifying less node-to-node variation of power of the distributed computing job to reduce task wait time to synchronization.

Example 50 incorporates the subject matter of any combination of Examples 46-49. In this example, the selection criterion includes a power criterion to decrease power consumption of the computing event as executed.

Example 51 incorporates the subject matter of any combination of Examples 46-50. In this example, the selection criterion involves compute unit-to-compute unit variation in power.

Example 52 incorporates the subject matter of any combination of Examples 46-51. In this example, the compute units are a processor core, a processor, a processor package, a compute node, or a server system, or any combination thereof.

Example 53 incorporates the subject matter of any combination of Examples 46-52. In this example, the selection criterion includes a power criterion of lower or lowest power.

Example 54 incorporates the subject matter of any combination of Examples 46-53. In this example, the selection criterion includes a power criterion of low variation of power compute unit-to-compute unit.

Example 55 incorporates the subject matter of any combination of Examples 46-54. In this example, the distribution characteristic includes a power profile.

Example 56 incorporates the subject matter of any combination of Examples 46-55. In this example, the distribution characteristic includes a temperature profile.

Example 57 incorporates the subject matter of any combination of Examples 46-56. In this example, the selection criterion includes a high power criterion to increase power consumption of the computing event as executed to meet a specified allocation of power for a facility comprising the system for computing.

Example 58 incorporates the subject matter of any combination of Examples 46-57. In this example, the selection criterion includes a lower or lowest power criterion that results in decreasing power consumption of the computing event as executed.

Example 59 incorporates the subject matter of any combination of Examples 46-58. In this example, the selection criterion includes lower power consumption and lower power variation, the power characteristic including a power profile, and the thermal characteristic including a thermal profile.

Example 60 incorporates the subject matter of any combination of Examples 46-59. In this example, the computing event is a distributed computing job, the compute units are nodes, and the selection criterion includes a power criterion of node-to-node variation of power.

Example 61 incorporates the subject matter of any combination of Examples 46-60. In this example, selecting the one or more nodes results in decreasing the node-to-node variation of the power of the job as executed to cause a reduce task wait time to synchronization.

Example 62 incorporates the subject matter of any combination of Examples 46-61. In this example, the selection criterion is or includes a thermal criterion.

Example 63 is a non-transitory, computer-readable medium having instructions executable by a processor to calibrate the compute units to determine a characteristic of the compute units, the characteristic including a power characteristic or a thermal characteristic, or a combination thereof, and wherein the compute units are configured to execute a computing event, the computing event including a server application or a distributed computing job. The instructions are executable by the processor to receive a selection criterion, and select one or more of the compute units to run the computing event based on the selection criterion and on the characteristic.

Example 64 incorporates the subject matter of Examples 63. In this example, the compute units are a processor core, a processor, a processor package, a compute node, or a server system, or any combination thereof.

Example 65 incorporates the subject matter of any combination of Examples 63-64. In this example, the selection criterion includes a high power criterion to increase power consumption of the computing event as executed to meet a specified allocation of power for a facility comprising the system for computing.

Example 66 incorporates the subject matter of any combination of Examples 63-65. In this example, the compute units are compute nodes or processors, or a combination thereof, and wherein the system is a distributed computing system having the compute nodes or processors, or both.

Example 67 incorporates the subject matter of any combination of Examples 63-66. In this example, the computing event is a distributed computing job, the compute units are nodes, and the selection criterion includes a power criterion of node-to-node variation of power.

Example 68 incorporates the subject matter of any combination of Examples 63-67. In this example, to select the one or more nodes is to decrease the node-to-node variation of the power of the job as executed to reduce task wait time to synchronization.

Example 69 incorporates the subject matter of any combination of Examples 63-68. In this example, the selection criterion is or includes a thermal criterion.

It is to be understood that specifics in the aforementioned examples may be used anywhere in one or more embodiments. For instance, all optional features of the computing device described above may also be implemented with respect to either of the methods described herein or a computer-readable medium. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A system for computing, comprising:
compute units configured to execute a computing event, the computing event comprising a server application or a distributed computing job; and
memory storing code executable by the compute units or a processor to:
calibrate the compute units to determine a characteristic of the compute units, the characteristic comprising a power characteristic or a thermal characteristic, or a combination thereof;
receive a selection criterion; and
select one or more of the compute units to run the computing event based on the selection criterion and on the characteristic.

2. The system of claim 1, wherein the compute units comprise a processor core, a processor, a processor package, a compute node, or a server system, or any combination thereof.

3. The system of claim 1, wherein the selection criterion comprises a power criterion comprising lower or lowest power.

4. The system of claim 1, wherein the selection criterion comprises a power criterion comprising lower power variation of compute unit-to-compute unit.

5. The system of claim 1, wherein the selection criterion comprises a high power criterion to increase power consumption of the computing event as executed to meet a specified allocation of power for a facility comprising the system for computing.

6. The system of claim 1, wherein the compute units comprise compute nodes or processors, or a combination thereof.

7. The system of claim 1, wherein the system comprises a distributed computing system, wherein the computing event comprises a distributed computing job, and wherein to select the one or more compute units increases the power consumption of the distributed computing job as executed to meet a specified allocation of power for a facility comprising the distributed computing system.

8. The system of claim 1, wherein the selection criterion comprises a low power criterion, and wherein to select the one or more compute units decreases power consumption of the computing event as executed.

9. The system of claim 1, wherein the selection criterion comprises lower power consumption and lower power variation, the power characteristic comprises a power profile, and the thermal characteristic comprises a thermal profile.

10. The system of claim 1, wherein the computing event comprises a distributed computing job, the compute units comprise nodes, and the selection criterion comprises a power criterion comprising node-to-node variation of power.

11. The system of claim 10, wherein to select the one or more nodes comprises to decrease the node-to-node variation of the power of the job as executed to reduce task wait time to synchronization.

12. The system of claim 1, wherein the selection criterion comprises a thermal criterion.

13. The system of claim 1, wherein the compute units comprise nodes, and where to calibrate the nodes comprises to measure power of the nodes as a function of operating frequency of the nodes.

14. The system of claim 1, wherein to select the one or more of the compute units comprises to select available compute units of the compute units.

15. The system of claim 14, wherein to select the one or more of the compute units comprises to select available compute units as eligible based on latency criteria.

16. A method of computing, comprising:
calibrating, via a processor, compute units of a system of computing to determine a distribution characteristic of the compute units, the distribution characteristic comprising a power characteristic or a thermal characteristic, or a combination thereof;
receiving, via the processor, a selection criterion;
selecting, via the processor and based on the selection criterion, one or more of the compute units to execute a computing event on the system; and
executing the computing event on the one or more compute units as selected.

17. The method of claim 16, wherein the selection criterion comprises a power criterion, and wherein the compute units comprise compute nodes or processors, or both.

18. The method of claim 17, wherein the system comprises a distributed computing system, the computing event comprises a job of distributed computing, and wherein the power criterion comprises a high power criterion to increase power consumption of the job as executed to meet a specified allocation of power for a facility comprising the computing system.

19. The method of claim 16, wherein the computing event comprises a distributed computing job and the compute units comprise compute nodes, wherein the selection criterion comprises a power criterion specifying less node-to-node variation of power of the distributed computing job to reduce task wait time to synchronization.

20. The method of claim 16, wherein the selection criterion comprises a power criterion to decrease power consumption of the computing event as executed.

21. The method of claim 16, wherein the selection criterion comprises a compute unit-to-compute unit variation in power.

22. A non-transitory, computer-readable medium comprising instructions executable by a processor to:
calibrate nodes of a distributed computing system to determine a power profile of the nodes, the nodes configured to execute a job of distributed computing;
receive a power criterion; and
select one or more of the nodes to execute the job based on the power criterion and the power profile.

23. The non-transitory, computer-readable medium of claim 22, wherein the power criterion comprises a lower power criterion or a lowest variation power criterion, or a combination thereof.

24. The non-transitory, computer-readable medium of claim 22, wherein the power criterion comprises a high power criterion, and wherein to select the one or more nodes increases the power consumption of the job as executed to meet a specified allocation of power for a facility comprising the distributed computing system.

25. The non-transitory, computer-readable medium of claim 22, wherein the power criterion comprises to decrease node-to-node variation of the power of the job as executed to reduce task wait time to synchronization.
